(19) United States
(12) Patent Application Publication
(10) Pub. No.: US 2012/0096043 A1
(43) Pub. Date: Apr. 19, 2012

(54) DATA GRAPH CLOUD SYSTEM AND METHOD

(75) Inventor: Paul Samuel Stevens, JR., Salt Lake City, UT (US)

(73) Assignee: 7 Degrees, Inc., Cottonwood Heights, UT (US)

(21) Appl. No.: 12/907,164

(22) Filed: Oct. 19, 2010

(51) Int. Cl. G06F 17/30; G06F 9/46

(52) U.S. Cl. 707/798; 718/100; 707/E17.011

(57) ABSTRACT

A computer-implemented method for managing updates for a node in a graph is described. An update relating to a node is received. The update is written to a graph database file system. A node update message is broadcast to at least one graph server when the update includes a change to a characteristic of the node.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computer systems may be used to carry out several business, industry, and academic endeavors. The wide-spread use of computers has been accelerated by the increased use of computer networks, including the Internet.

Many businesses use one or more computer networks to communicate and share data between the various computers connected to the networks. The productivity and efficiency of employees often require human and computer interaction. Users of computer technologies continue to demand that the efficiency of these technologies increase. Improving the efficiency of computer technologies is important to anyone that uses and relies on computers.

Graph database systems are used for a number of analytical purposes. Applications implemented by graph database systems operate on relatively small amounts of data in order to prove a theory. Graph database systems are also used as analytical tools for specialized research teams. The results provided by graph database systems provide information relating to connections between people, businesses, events, and the like.

The increase of information about people, businesses, events, etc. has resulted in creating large collections of data for graph database systems to process. The volume, organization, and capabilities required to process the data often lead to ineffective generation of graphs by graph database systems.

### SUMMARY

According to at least one embodiment, a computer-implemented method for managing updates for a node in a graph is described. An update relating to a node is received. The update is written to a graph database file system. A node update message is broadcast to at least one graph server when the update includes a change to a characteristic of the node.

In one configuration, additional information relating to the node may be synchronized from a relational database. The graph database file system may be updated with the received update and the additional information relating to the node. In one example, the relational database stores non-critical data relating to the node. Non-critical data may include data that are not used to traverse among one or more nodes in a path of a graph. In one embodiment, the graph database file system may store critical data relating to the node. Critical data may include data that are used to traverse among one or more nodes in a path of a graph.

A computing device configured to manage updates for a node in a graph is also described. The computing device may include a processor and memory in electronic communication with the processor. The processor may be configured to receive an update relating to a node. The computing device may include a writing module configured to write the update to a graph database file system. In addition, the computing device may include a broadcasting module configured to broadcast a node update message to at least one graph server when the update includes a change to a characteristic of the node.

A computer-program product for managing updates for a node in a graph is also described. The computer-program product may include a computer-readable medium having instructions thereon. The instructions may include code programmed to receive an update relating to a node and code programmed to write the update to a graph database file system. The instructions may further include code programmed to broadcast a node update message to at least one graph server when the update includes a change to a characteristic of the node.

A computer-implemented method for managing a request sent from a client computing device to a graph database system is also described. In one embodiment, a request to perform an action is received from a client computing device. The request may be stored in a task queue. Information may be associated with the request that indicates the type of request received from the client. The associated information may indicate at least one capability needed to execute the request and perform the action.

A computer-implemented method for managing nodes stored in a local cache based on a received broadcast message is also described. An invalidity message relating to a node stored in a local cache may be received. Information associated with the node stored in cache may be invalidated. Additional information for the node may be read from a graph database file system. The information associated with the node in the local cache may be updated with the additional information read from the graph database file system.

A computer-implemented method for processing a request stored in a task queue is also described. A request may be pulled from a task queue. The request may be analyzed. The request may be processed when capabilities needed to process the request are present. At least one registered plug-in may provide at least one capability to process the request. The processed request may be stored for retrieval.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of a graph database system in which the present systems and methods may be implemented;

FIG. 2A is a block diagram illustrating one embodiment of an application server;

FIG. 2B is a block diagram illustrating one embodiment of a graph server writer;

FIG. 2C is a block diagram illustrating one embodiment of a task queue;

FIG. 3 illustrates a block diagram illustrating one embodiment of a graph server reader;

FIG. 4 is a flow diagram illustrating one embodiment of a method to manage updates received at the graph server writer;

FIG. 5 is a flow diagram illustrating one embodiment of a method for managing a request sent from a client computing device to a graph database system;

FIG. 6 is a flow diagram illustrating one embodiment of a method for managing nodes stored in a local cache based on a broadcast received from a graph server writer;

FIG. 7 is a flow diagram illustrating one embodiment of a method for processing a request stored in a task queue;

FIG. 8 depicts a block diagram of a computer system suitable for implementing the present systems and methods; and

FIG. 9 is a block diagram depicting a network architecture in which client systems, as well as storage servers (any of which can be implemented using computer system), are coupled to a network.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

A graph database is a database that may use graph structures with nodes, edges, and properties to represent and store information. Nodes may be objects in a graph database that do not depend on other objects. Edges may be objects that depend on the existence of other objects (e.g., a source object and a destination object). Edges may be referred to as arcs.

Graph database systems have existed in several forms and may be used for a number of analytical purposes. Many of the applications implemented by graph database systems have operated on relatively small amounts of data in order to prove a theory. Graph database systems have also been used as analytical tools for specialized research teams. Current graph database systems attempt to process large amounts of data, and act as a server, but are still largely designed to run within an organization to help solve a specific analytic problem. Their architecture does not currently allow for real time unlimited access over the Internet. Current graph database systems also do not allow users to upload their own data processing algorithms to a graph database hosted in the cloud.

The present systems and methods describe a process for creating a graph database system capable of being used on a large scale to power cloud or Software as a Service (SaaS) based applications servicing many simultaneous users and running many simultaneous algorithms. In one embodiment, the present systems and methods may enable a website to provide a service powered by a graph database. The present systems and methods may make it possible to perform graph theory against a large graph, while also servicing many simultaneous users. Previous graph database systems focus on scaling on total data size, but do not address accessing data with many simultaneous users and applying dynamic algorithms with real time user input. The present systems and methods provide a graph database system that is scalable in terms of amount of data, is capable of supporting a large number of simultaneous users, and is capable of providing real time graph analytics while the user waits.

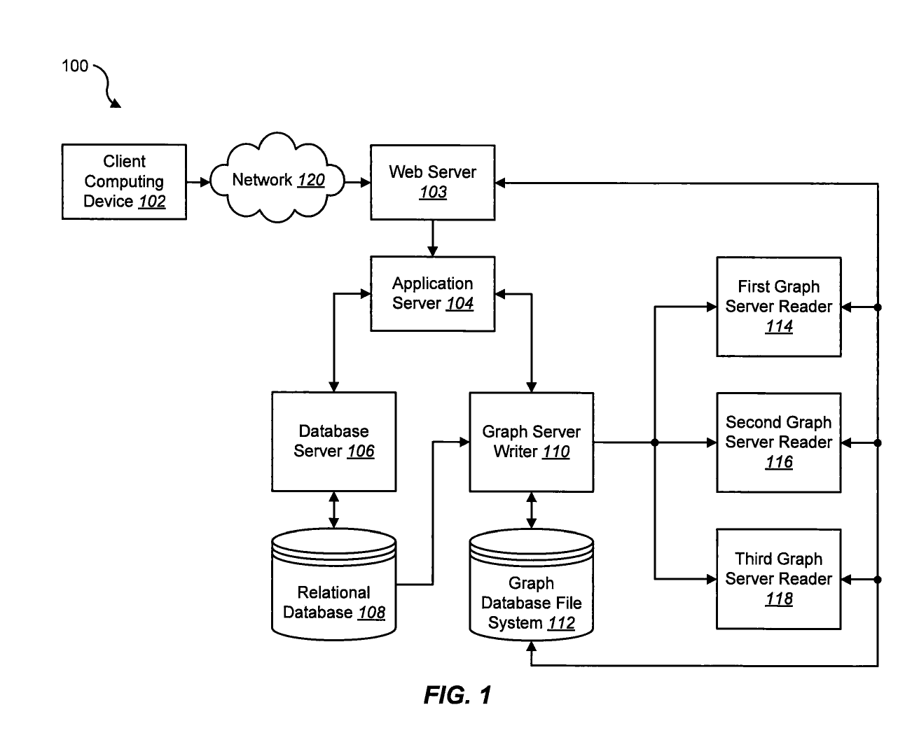

FIG. 1 is a block diagram illustrating one embodiment of a graph database system 100 in which the present systems and methods may be implemented. In one configuration, a client computing device 102 may communicate with a web server 103 across a network connection 120. The web server 103 may be an interface for the client computing device 102. In one embodiment, the computing device 102 may communicate with the web server 103 using graph application programming interfaces (API) that may be available over a hypertext transfer protocol (HTTP).

The web server 103 may transmit data received from the client computing device 102 to an application server 104. The application server 104 may include a graph API data layer that processed the data received from the client computing device 102. In one example, the application server 104 may determine the appropriate data store for the data received from the client computing device 102. For example, the application server 104 may transmit the data received from the client computing device 102 to a relational database 108 (associated with a database server 106) or to a graph database file system 112 (associated with a graph server writer 110). In one configuration, data that relates to an object of a graph may be written to either the graph database file system 112 or the relational database 108. Data that are a query (or request) to perform a certain action may be written to a task queue. In one embodiment, the task queue may be stored in the relational database 108. The task queue may be global or a specific queue.

The graph database system 100 may also include one or more graph server readers 114, 116, 118. In one configuration, the readers 114, 116, 118 may pull or listen for certain tasks in the task queue based on registered capabilities of the specific graph server reader 114, 116, 118. For example, the first graph server reader 114 may communicate with the web server 103 to request tasks that require the capabilities registered to the first graph server reader 114. The web server 103 may communicate this request to the application server 104, which may pull tasks from the task queue and transmit the tasks back to the first graph server reader 114 via the web server 103.

In one embodiment, the first graph server reader 114 may process the task and return the results to a client registered callback or store the results in a database with a client identifier for retrieval. Clients may pull or request results and processing status once a query request has been written to the task queue. In one embodiment, the task queue may be stored in a messaging server or any other device or data store included in the graph database system 100.

As previously explained, data received at the application server 104 that relate to an object for a graph may be written in to either the relational database 108 or the graph database file system 112. For example, data for an object that are non-critical data may be stored in the relational database 108. Non-critical data may be data that are not necessary to traverse among objects in a path of a graph. In order to implement a large scale project with a graph database, it may be necessary to store additional information about objects (such as a node) and to index the objects based on that additional information. Current graph database systems attempt to create a master record of all data for a graph by storing all the information for objects of a graph in a single database. The present systems and methods store data that are not critical or needed in graph traversal algorithms in the relational database 108.

Data that are critical and needed in graph traversal algorithms may be stored in the graph database file system 112. As a result, if the received data include critical data (i.e., data that are necessary for graph traversal algorithms, such as an identifier of an object), the data may be stored in the graph database file system 112. Objects (i.e., nodes) may then be represented in the graph database file system 112 as a target list of identifiers and an associated weight. Any information not essential for graph traversal may be looked up in the relational database 108 based on a node identifier or relationship identifier in the relational database 108 and appended onto the result after the traversal. The relational database 108 may also be used to manage backups and replication and may be the master record of all data. All information to create relationships may be stored in the relational database 108 and time stamped. The graph database file system 112 may then rebuild itself from the relational database 108 at any point in time.

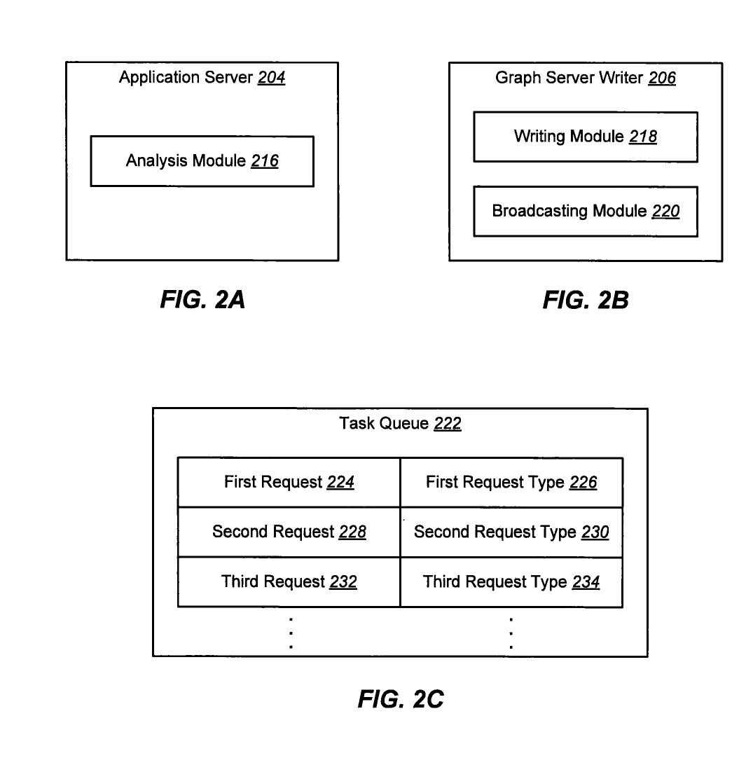

FIG. 2A is a block diagram illustrating one embodiment of an application server 204. The application server 204 may include an analysis module 216 to analyze data received from a client computing device 102 via a web server 103.

In one example, the analysis module 216 may analyze an update received from the client computing device 102 via the web server 103. The analysis module 216 may determine whether the update includes a change to critical information associated with the node (e.g., an identifier for the node) or non-critical information for the node. If the update includes changes to non-critical information for the node, the application server 204 may transmit the update to the database server 106 to be written in the relational database. If, however, the update includes a change to critical information for the node, the application server 204 may transmit the update to the graph server writer 110 to be written in the graph database file system 112.

FIG. 2B is a block diagram illustrating one embodiment of a graph server writer 206. In one configuration, the graph server writer 206 may include a writing module 218 that may write an update for a node to the graph database file system 112. The graph server writer 206 may also include a broadcasting module 220. If a received update for a node includes a change to the identifier of the node (or a change to other critical information relating to the node), the broadcasting module 220 may broadcast the change to graph server readers 114, 116, 118 that have subscribed with the graph server writer 206. Each graph server reader 114, 116, 118 may store information about each node of a graph in a local cache. After the readers 114, 116, 118 receive a message from the broadcasting module 220 relating to an identifier change for a particular node, the readers 114, 116, 118 may mark that particular node in their local cache as invalid.

FIG. 2C is a block diagram illustrating one embodiment of a task queue 222. In one configuration, an update received at the application server 104 from a client computing device 102 (via the web server 103) may be a request for a graph server reader 114, 116, 118 to perform a certain action. If the update is a request, the request may be stored in the task queue 222. As previously explained, the task queue 222 may be stored in the relational database 108. In another embodiment, the task queue 222 may be stored in other databases or data stores associated with the graph database system 100.

In one configuration, each request stored in the task queue 222 may be a certain type of request. For example, a first request 224 stored in the task queue 222. The first request 224 may be of a first request type 226. Similarly, a second request 228 and a third request 232 stored in the task queue 222 may be a second request type 230 and a third request type 234, respectively.

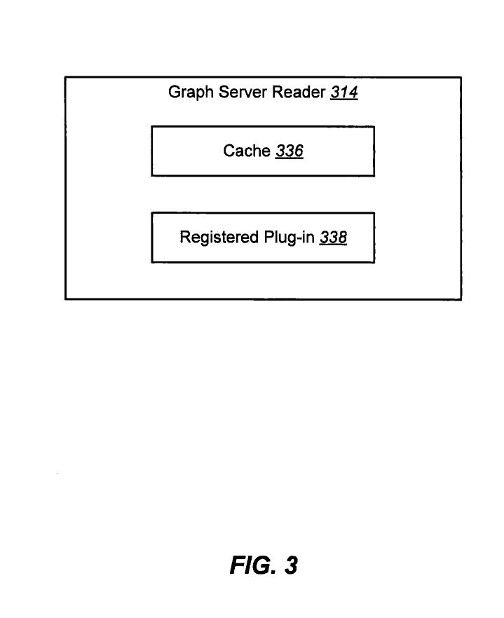

FIG. 3 illustrates a block diagram illustrating one embodiment of a graph server reader 314. In one configuration, the graph server 314 may include a cache 336 and at least one registered plug-in 338.

As previously explained, a node may include information about other target nodes and connections between other nodes. Currently, connected nodes are opened (or accessed) directly from disk (i.e., file system) when traversing a path in a graph. A cache on a graph server reader 314 that also stores nodes in the graph may allow the traversal of the graph to be more efficient. For example, storing nodes in the local cache 336 of the graph server reader 314 may eliminate the need to open (or access) a node from the graph database file system 112 during traversal of a path in the graph. In the graph database system 100, this may be more complex since there can be many graph server readers and only a single graph server writer. When the graph server writer 110 modifies a node, by adding a new target or changing a node attribute, the changes may be broadcast from the graph server writer 110 to the other graph server readers. This broadcast may signify to the graph server readers that the specified node is invalid. Upon receiving this broadcast, the graph server reader 314 may check its cache 336 and remove the node from cache 336 so that the node (with the updated information) will be reloaded from the graph database file system 112. In one embodiment, the graph server writer 110 and the graph server readers may all point to the same attached network file system (such as the graph database file system 112) for consistent data access. In another embodiment, instead of being removed immediately from the cache 336, the node may simply be flagged or marked for a reload in case existing threads running in the graph database system 100 still have a need for direct reference to the node stored in cache 336. In one example, the broadcast may include the update information for the node. As a result, each graph server reader 314 that receives the broadcast may update the node stored in its respective cache 336 with the update information included in the broadcast message.

In one embodiment, graph problems may require random disk input/output since data are connected in a way such that locality of any particular node on disk and its connected nodes may lead to fragmentation for all connected nodes and their related data. As a result, a distributed system with nodes shared across multiple servers may not scale properly and still provide adequate performance for intense graph theory algorithms such as path finding. Although this distribution of nodes technique could be used for interactive graph navigation, it may not effectively be used for path finding, which may require locality of nodes on a file system 112 in order to return results in real time. In order to obtain fast traversals, it may be necessary to cache all nodes involved in the traversal of a graph in a local cache, such as the cache 336, on each distributed graph server reader in the graph database system 100 (such as the graph server reader 314).

In one example, it may not be scalable to the billions of nodes to cache all deserialized nodes. It may be possible, however, to store a compressed format of each node in the local cache of each graph server reader as stored on the file system 112. In one example, the compressed format may be mapped into memory and this may allow the scalability to the many billions of nodes. In addition, as previously described, this may avoid the need to access the disk (or graph database file system 112) during traversal of a graph.

In one embodiment, data may not expire from the cache 336. A primer process may be executed to place all nodes in the graph in the cache 336 on start-up of the graph server reader 314. This primer process may be created by stopping new writes to the graph server writer 110 and having the graph server writer 110 dump its current contents in the graph database file system 112, or regenerate the cache 336 for the graph server reader 314 from the nodes in the file system 112. In one embodiment, new nodes may be then be loaded on access and maintained in memory. As mentioned above, a particular entry in the cache 336 may be invalidated on broadcast of node changes from the graph server writer 112. The cache 336 may be an in-memory array by node identifiers and stored as compressed byte representations of each node.

In order to achieve adequate performance for a graph traversal algorithm, it may be necessary to be near the data. For example, it may not be possible to write a graph traversal algorithm used for finding the best path of a graph using web services. This may be caused by the fact that the search must explore millions of nodes as fast as possible. In order to achieve the level of performance and still make the algorithm available to many users, a registered plug-in 338 may be required. Graph algorithms may be written against the graphs native API by developers. Then the registered plug-in 338 may be deployed against all servers in the graph database system 100 and made available for access with user defined parameters. The graph database system 100 may expose the plug-in call with a generic interface allowing users to pass their own specific parameters understood by the plug-in 338. Plug-ins may be distributed out to all graph server readers that are registered to run this algorithm. Queries to the plug-in 338 may run against any graph server reader that is registered to run the plug-in 338.

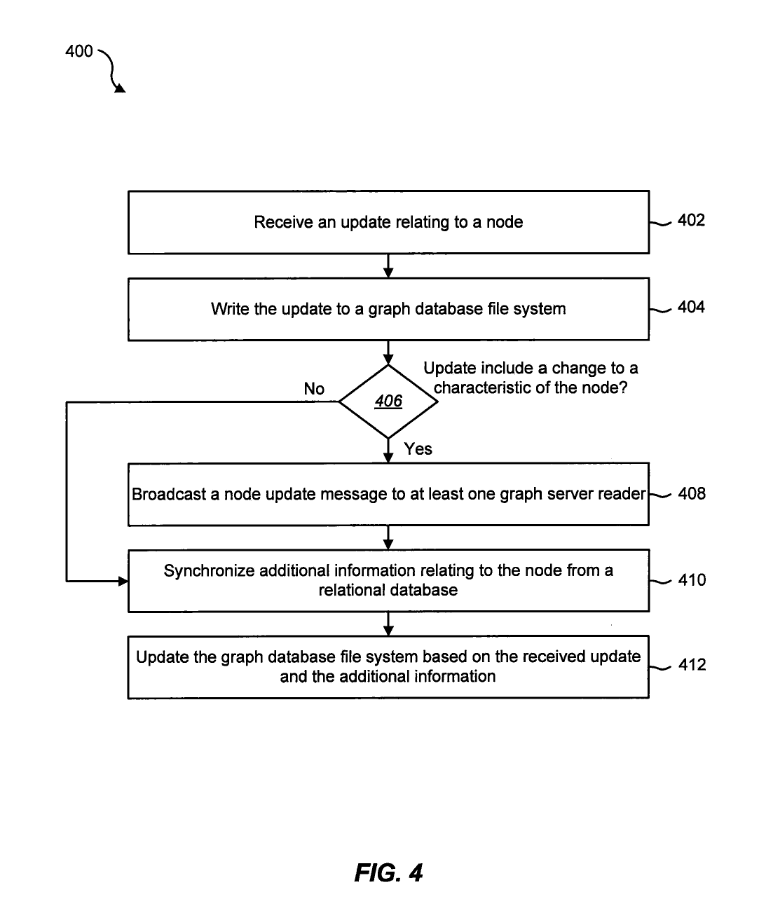

FIG. 4 is a flow diagram illustrating one embodiment of a method 400 to manage updates received at the graph server writer 110. In one configuration, the method 400 may be implemented by the graph server writer 110.

In one embodiment, an update relating to a node may be received 402. The update may be written 404 to a graph database file system. A determination 406 may be made as to whether the update includes a change to a characteristic of the node. If it is determined that the update does include a change to a characteristic of the node, a node update message may be broadcast 408 to at least one graph server reader registered with the graph server writer 110. If, however, it is determined 406 that the update does not include a change to a characteristic of the node, a broadcast message may not be sent to the graph server readers registered with the graph server writer 110.

In one configuration, additional information relating to the node from the relational database 108 may be synchronized 410 with information stored in the graph database file system 112. In one embodiment, the graph database file system may be updated 412 based on the received update and the additional information synchronized 410 from the relational database.

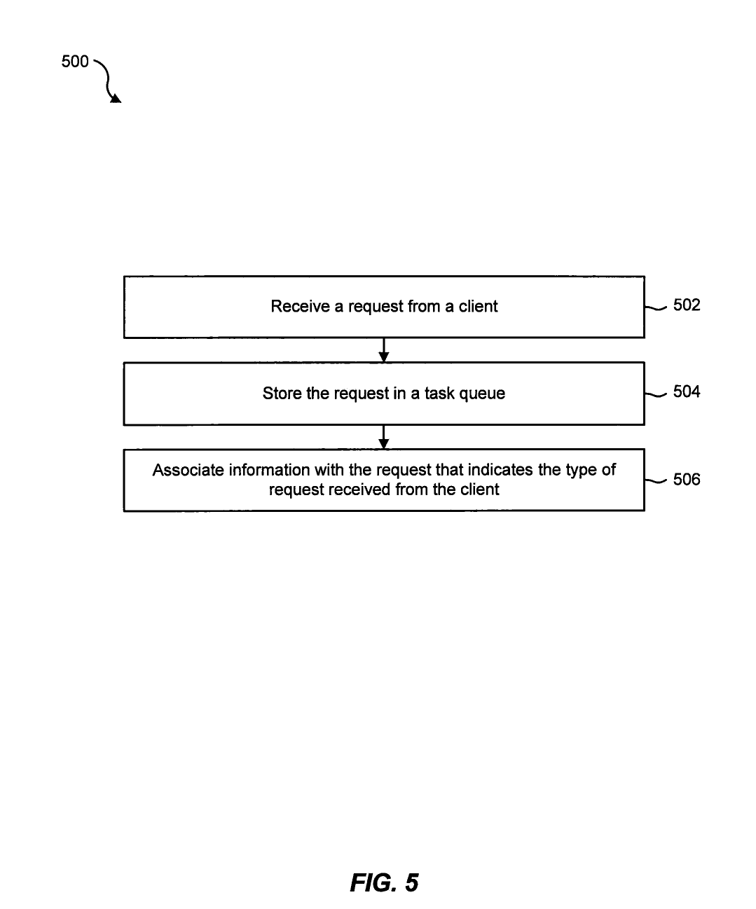

FIG. 5 is a flow diagram illustrating one embodiment of a method 500 for managing a request sent from a client computing device 102 to a graph database system 100. In one configuration, the method 500 may be implemented by the database server 106 in the graph database system 100. In another configuration, the method 500 may be implemented by any other device in the graph database system 100 that stores the task queue 222.

In one embodiment, a request may be received 502 from a client computing device 102. The request may be received 502 from the client computing device 102 via a web server 103 and an application server 104. The request may be a request for a graph server reader 114, 116, 118 to perform a certain action, execute a certain process, produce a result, and the like. In one configuration, the request may be stored 504 in the task queue 222. In one configuration, information may be associated 506 with the request that indicates the type of the request received from the client computing device 102. The information indicating what type the request is may also be stored in the task queue 222. In one example, only graph server readers 114, 116, 118 that are capable of executing requests of that particular type may fulfill the request.

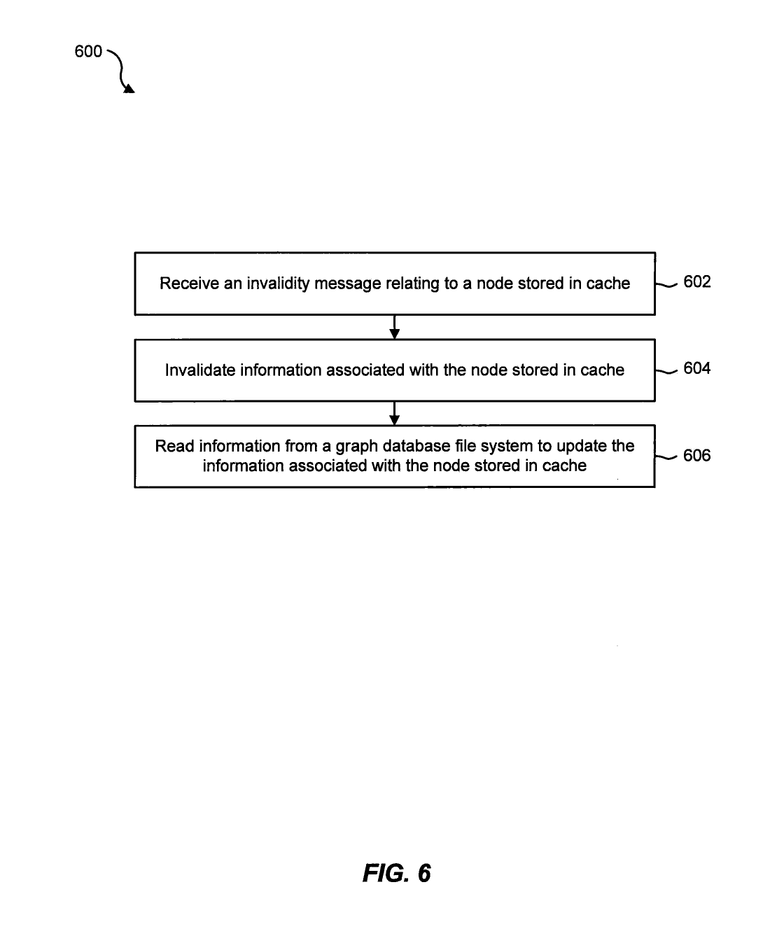

FIG. 6 is a flow diagram illustrating one embodiment of a method 600 for managing nodes stored in a local cache based on a broadcast received from a graph server writer 110. In one embodiment, the method 600 may be implemented by a graph server reader.

In one example, an invalidity message relating to a node stored in local cache may be received 602. Information associated with the node stored in cache may be invalidated 604. As a result, the invalid node may not be accessed by a graph traversal algorithm. Information may be read 606 from a graph database file system 112 to update the information associated with the node stored in the cache of the graph server reader. The information read 606 from the graph database file system 112 may be an update for the information previously invalidated in the local cache. After the information has been read 606 from the graph database file system 112, the node may no longer be invalidated in the local cache of the graph server reader.

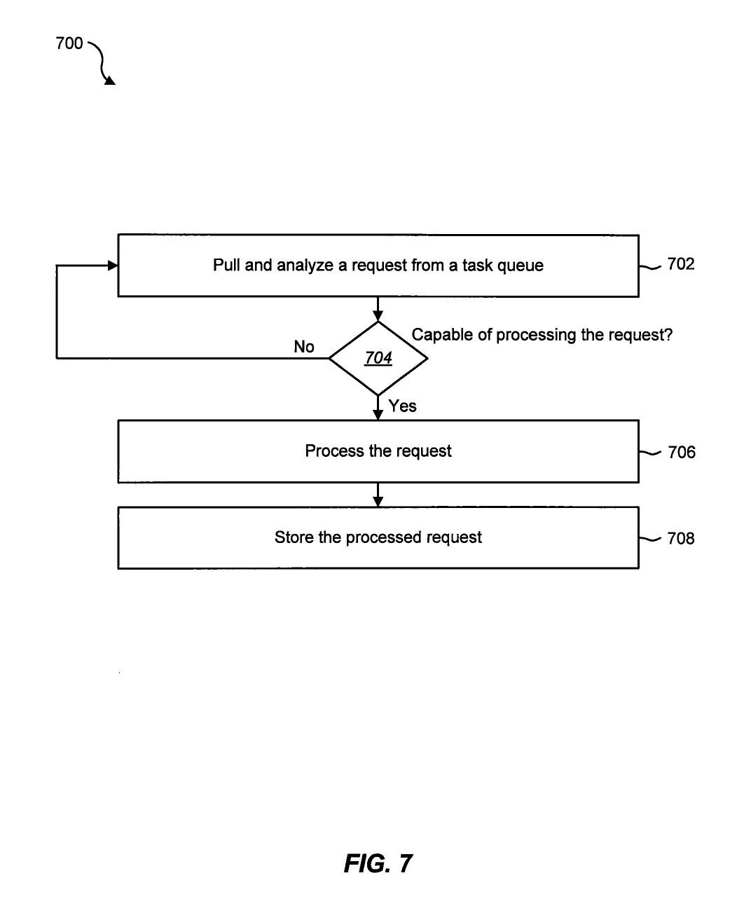

FIG. 7 is a flow diagram illustrating one embodiment of a method 700 for processing a request stored in a task queue. In one configuration, the method 700 may be implemented by a graph server reader.

In one embodiment, a request may be pulled 702 and analyzed from a task queue. For example, a graph server reader 114 may send a notification to the web server 103 that the reader 114 is capable of processing a particular type (or types) of requests. The web server 103 may provide this notification to the application server 104, which in turn may provide the notification to the database server 108. The notification server 106 may pull at least one request from the task queue 222 stored in the relational database 108 that is of the type the reader 114 is capable of processing. The request may be passed back to the reader 114.

In one embodiment, a determination 704 may be made as to whether the graph server reader 114 is capable of processing the request received from the web server 103. If it is determined 704 that the graph server reader is not capable of processing the request, method 700 may return to pull 702 and analyze a different request from the task queue 222 as explained above. If, however, it is determined 704 that the graph server reader 114 is capable of processing the request, the request may be processed 706. In addition, the processed request may be stored 708 for retrieval by a client computing device 102 that first submitted the request to the task queue 222.

In one embodiment, a graph server (either the graph server writer 110 or a graph server reader 114, 116, 118) may allow sessions to run queries or inference rules that create subgraphs. The query may be run directly, or may be designed as a plug-in. A server call may designate to return the result, or to register the result as a subgraph. Only results that return graph data records may store a subgraph. This call may return a subgraph identifier for the subgraph just created. This subgraph may either be temporary by session, or permanent for all users to view. In one embodiment, administration privileges may be required to create a subgraph for all users. All the calls on the graph server API that operate on a graph may take another parameter for the subgraph identifier and the call may run against the subgraph instead of the main graph.

In one configuration, a graph server may also maintain multiple sessions. A graph server may also allow multiple graph access. When a new session is created, another call may be made to assign an open graph to that session. It may be possible for many different sessions to be running on the graph server at a time. Each session call may operate on one graph at a time, but different sessions may be simultaneously operating on the same or different graphs at the same time.

Synchronous calls may be made directly against the graph since the graph database system 100 may be thread safe. For asynchronous calls, a new object may be created and assigned and saved to a session. This object may then start the running operation on the graph. When the session makes additional calls to the graph server to check the status of the long running call, the graph server may look up the object for that session to get any results, determine the current status, or even cancel the operation. This design may require that only one operation type be running on the server for a given session of time. If multiple asynchronous operations of the same type are needed, they may be started in separate sessions.

The graph server may also allow complete control over the number of calls it allows to run at the same time. The graph server may have options to specify the maximum total weight of asynchronous calls allowed. Each asynchronous call type may be assigned a weight value. Higher weights may usually be assigned to more expensive calls. Each time an asynchronous call is made, the weight for the call type may be added to a sum on the graph server. When a call finishes, the count may be decremented. If the maximum allowed weight is exceeded, the graph server may queue the calls up to a specified level. If that level is reached, any incoming asynchronous calls may be rejected.

Synchronous calls may also operate in a similar manner, with a configurable maximum allowed weight. There may be only one configurable weight, however, for all synchronous calls, instead of having weights by different types of synchronous calls. This may be significant to the graph server, since graph analytics may require the resources of a central processing unit (CPU) as well as memory usage. The configurable graph database system 100 may allow for each graph server (the graph server writer 110 and the graph server readers 114, 116, 118) to operate in a stable environment, and as more users are supported, more instances of graph servers may be added.

The access to the graph may be further scaled by adding many instances of a graph server that may access the same set of graph data files. There may be an unlimited number of graph server readers 114, 116, 118, but there may be one graph server writer 110. All writes may be routed to the graph server writer 110.

The various servers 106, 110, 114, 116, 118 may represent all the graph concepts as serial objects so that they can be passed efficiently across the network in a web service or remote call. Objects may have the potential to hold extra information than may be requested and the amount of fields populated may be determined by the detail level of the call. For example, when querying a graph server for a node, a NodeRecord may be returned. The NodeRecord may hold information for all attributes of the node. If the detail level of the call was not set to return attributes, only the node identifier and the main value may be populated in the return call. This may allow for efficient retrieval of only the information needed and may also minimize the number of remote calls when all information about a node is needed.

In one embodiment, graph traversal algorithms may include shortest path, weighted path, centrality, and graph query language (GQL) queries as asynchronous calls. All the calls to add information to the graph, or to get a specific graph object (such as a node or a list of nodes, attributes of nodes, targets of nodes) may all be synchronous calls. The decision for making a call asynchronous may depend on whether the call has the potential to run for an extended period of time. All graph analytics may have this potential, so they may be made asynchronous in order to improve the user experience. Asynchronous calls may also provide results as they are found and may be cancelled. For example, a graph query may be started and the user may desire to find up to one hundred results. However, it may be that increased speed may be desirable to the user at some point. As a result, the user may opt for twenty-five results as the minimum and may not want to wait longer than thirty seconds to receive the results. The asynchronous call design may allow this flexibility. Results may be retrieved while the call is still running so that they can be reported back to the user in real time.

The graph server may process various data types. The data types may be described by working back from two types of calls, a graph query call (GQL) and a shortest path call. Since GQL may be used to find patterns or a series of paths, the return result may include an array of graphs. A shortest path call may be more specific than a GQL query and may return an array of paths as the result. The path and the graph results may demonstrate some of the data types used to communicate graph information.

In one example, a GQL query may return QueryResultsGraphRecord. This type may include a nodeToHighlight member that indicates the focus node or the nodes that satisfied the nodes specifications from the query. The other member may be a GraphRecord. A GraphRecord may represent a graph and may contain an array of NodeRecords and an array of PathElements. The NodeRecord class may include the identifier for the node and a NodeRecordValues member. The NodeRecordValues class may include a string value for the node class of the node and an object type for the nodes main value. In one configuration, the attributes of the node may be in an AttributeRecord array. An AttributeRecord may include the name of the attribute and an object member or the value of the attribute.

In one embodiment, a target list of a node may be found by consolidating all of the connections described in the PathElement array. The PathElement may describe a link between two nodes in the graph. In one example, the PathElement may have a source node identifier, a “to direction” arc ID, a “to direction” arc weight, a “from direction” arc ID, a “from direction” arc weight, and a target node ID. The combination of the NodeRecord array and PathElement array may provide a way to describe a graph and communicate it through remote web service calls. The data structures may use non-complex types when possible to make for straight-forward serialization and to help enter operability between different application web services. The graph server may also provide the ability to pass in a detail level on all calls that return a GraphRecord, so that only the details that are needed may be returned. This may allow the user to receive as little or as much information as possible in a single call and thus reduce the amount of network traffic required.

The shortest path call may return an array of PathElements. They may be very similar to the GQL query call except that descriptive information on the nodes may not be provided. Only the path elements may be provided with the node identifiers. Thus, if more information is needed on the nodes, it may be a relatively easy operation to gather the required node identifiers and get a corresponding NodeRecord for the identifier with another call to the graph server. However, the main focus of the shortest path call may be to acquire the path information. The PathElement returned may be the same as that described above for the GQL query. If a descriptive path is needed with information on the nodes, another operation may be to make a GQL query call to find a path.

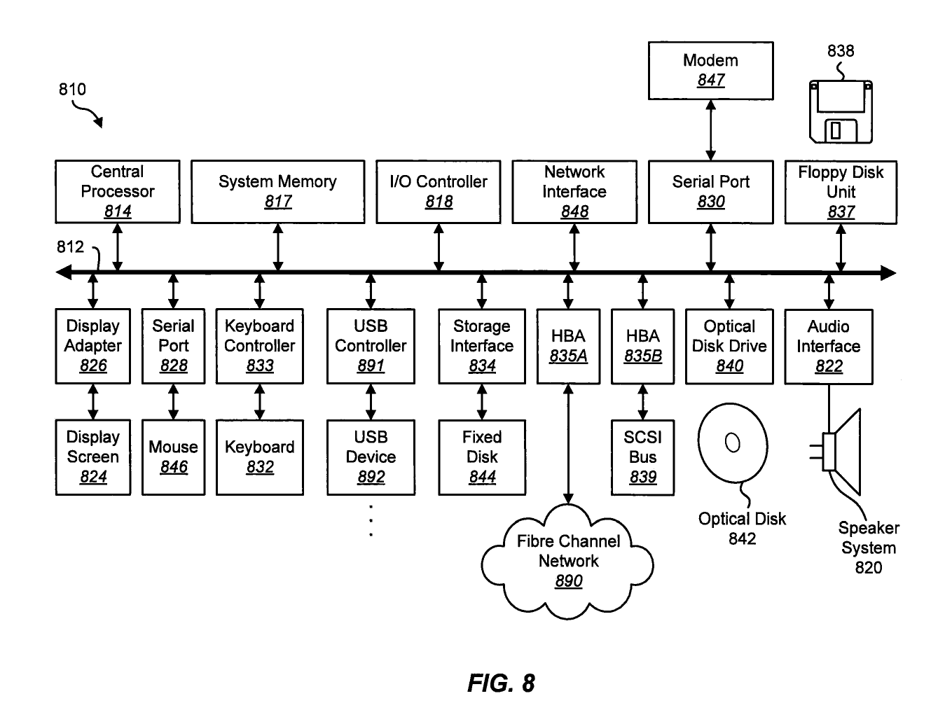

FIG. 8 depicts a block diagram of a computer system 810 suitable for implementing the present systems and methods. Computer system 810 includes a bus 812 which interconnects major subsystems of computer system 810, such as a central processor 814, a system memory 817 (typically RAM, but which may also include ROM, flash RAM, or the like), an input/output controller 818, an external audio device, such as a speaker system 820 via an audio output interface 822, an external device, such as a display screen 824 via display adapter 826, serial ports 828 and 830, a keyboard 832 (interfaced with a keyboard controller 833), multiple USB devices 892 (interfaced with a USB controller 890), a storage interface 834, a floppy disk drive 837 operative to receive a floppy disk 838, a host bus adapter (HBA) interface card 835A operative to connect with a Fibre Channel network 890, a host bus adapter (HBA) interface card 835B operative to connect to a SCSI bus 839, and an optical disk drive 840 operative to receive an optical disk 842. Also included are a mouse 846 (or other point-and-click device, coupled to bus 812 via serial port 828), a modem 847 (coupled to bus 812 via serial port 830), and a network interface 848 (coupled directly to bus 812).

Bus 812 allows data communication between central processor 814 and system memory 817, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. Applications resident with computer system 810 are generally stored on and accessed via a computer readable medium, such as a hard disk drive (e.g., fixed disk 844), an optical drive (e.g., optical drive 840), a floppy disk unit 837, or other storage medium. Additionally, applications can be in the form of electronic signals modulated in accordance with the application and data communication technology when accessed via network modem 847 or interface 848.

Storage interface 834, as with the other storage interfaces of computer system 810, can connect to a standard computer readable medium for storage and/or retrieval of information, such as a fixed disk drive 844. Fixed disk drive 844 may be a part of computer system 810 or may be separate and accessed through other interface systems. Modem 847 may provide a direct connection to a remote server via a telephone link or to the Internet via an internet service provider (ISP). Network interface 848 may provide a direct connection to a remote server via a direct network link to the Internet via a POP (point of presence). Network interface 848 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 8 need not be present to practice the present systems and methods. The devices and subsystems can be interconnected in different ways from that shown in FIG. 8. The operation of a computer system such as that shown in FIG. 8 is readily known in the art and is not discussed in detail in this application. Code to implement the present disclosure can be stored in computer-readable medium such as one or more of system memory 817, fixed disk 844, optical disk 842, or floppy disk 838. The operating system provided on computer system 810 may be MS-DOS®, MS-WINDOWS®, OS/2®, UNIX Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

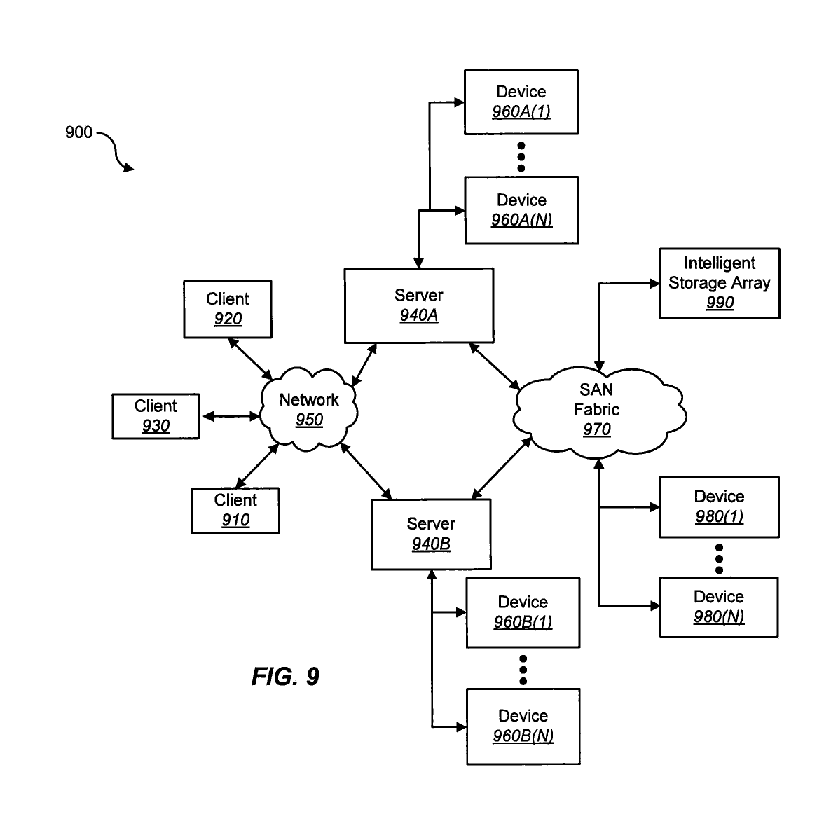

FIG. 9 is a block diagram depicting a network architecture 900 in which client systems 910, 920 and 930, as well as storage servers 940A and 940B (any of which can be implemented using computer system 910), are coupled to a network 950. The storage server 940A is further depicted as having storage devices 960A(1)-(N) directly attached, and storage server 940B is depicted with storage devices 960B(1)-(N) directly attached. SAN fabric 970 supports access to storage devices 980(1)-(N) by storage servers 940A and 940B, and so by client systems 910, 920 and 930 via network 950. Intelligent storage array 990 is also shown as an example of a specific storage device accessible via SAN fabric 970.

With reference to computer system 810, modem 847, network interface 848 or some other method can be used to provide connectivity from each of client computer systems 910, 920, and 930 to network 950. Client systems 910, 920, and 930 are able to access information on storage server 940A or 940B using, for example, a web browser or other client software (not shown). Such a client allows client systems 910, 920, and 930 to access data hosted by storage server 940A or 940B or one of storage devices 960A(1)-(N), 960B(1)-(N), 980(1)-(N) or intelligent storage array 990. FIG. 9 depicts the use of a network such as the Internet for exchanging data, but the present systems and methods are not limited to the Internet or any particular network-based environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A computer-implemented method for managing updates for a node in a graph, comprising:
receiving an update relating to a node;
writing the update to a graph database file system; and
broadcasting a node update message to at least one graph server when the update includes a change to a characteristic of the node.

2. The method of claim 1, further comprising synchronizing additional information relating to the node from a relational database.

3. The method of claim 2, further comprising updating the graph database file system with the received update and the additional information relating to the node.

4. The method of claim 2, wherein the relational database stores non-critical data relating to the node.

5. The method of claim 4, wherein non-critical data comprise data that are not used to traverse among one or more nodes in a path of a graph.

6. The method of claim 1, wherein the graph database file system stores critical data relating to the node.

7. The method of claim 6, wherein critical data comprise data that are used to traverse among one or more nodes in a path of a graph.

8. A computing device configured to manage updates for a node in a graph, comprising:
a processor;
memory in electronic communication with the processor;
the processor configured to receive an update relating to a node; and
a writing module configured to write the update to a graph database file system; and
a broadcasting module configured to broadcast a node update message to at least one graph server when the update includes a change to a characteristic of the node.

9. The computing device of claim 8, wherein the processor is further configured to synchronize additional information relating to the node from a relational database.

10. The computing device of claim 9, wherein the writing module is further configured to update the graph database file system with the received update and the additional information relating to the node.

11. The computing device of claim 9, wherein the relational database stores non-critical data relating to the node.

12. The computing device of claim 11, wherein non-critical data comprise data that are not used to traverse among one or more nodes in a path of a graph.

13. The computing device of claim 8, wherein the graph database file system stores critical data relating to the node.

14. The computing device of claim 13, wherein critical data comprise data that are used to traverse among one or more nodes in a path of a graph.

15. The computing device of claim 8, wherein the computing device is a graph server writer.

16. A computer-program product for managing updates for a node in a graph, the computer-program product comprising a computer-readable medium having instructions thereon, the instructions comprising:
code programmed to receive an update relating to a node;
code programmed to write the update to a graph database file system; and
code programmed to broadcast a node update message to at least one graph server when the update includes a change to a characteristic of the node.

17. The computer-program product of claim 16, wherein the instructions further comprise code programmed to synchronize additional information relating to the node from a relational database.

18. The computer-program product of claim 17, wherein the instructions further comprise code programmed to update the graph database file system with the received update and the additional information relating to the node.

19. The computer-program product of claim 17, wherein the relational database stores non-critical data relating to the node.

20. The computer-program product of claim 19, wherein non-critical data comprise data that are not used to traverse among one or more nodes in a path of a graph.

21. The computer-program product of claim 16, wherein the graph database file system stores critical data relating to the node.

22. The computer-program product of claim 21, wherein critical data comprise data that are used to traverse among one or more nodes in a path of a graph.

23. A computer-implemented method for managing a request sent from a client computing device to a graph database system, comprising:
receiving a request to perform an action from a client computing device;
storing the request in a task queue; and
associating information with the request that indicates the type of request received from the client, wherein the associated information indicates at least one capability needed to execute the request and perform the action.

24. A computer-implemented method for managing nodes stored in a local cache based on a received broadcast message, comprising:
receiving an invalidity message relating to a node stored in a local cache;
invalidating information associated with the node stored in cache; and
reading information from a graph database file system; and
updating the information associated with the node in the local cache with the information read from the graph database file system.

25. A computer-implemented method for processing a request stored in a task queue, comprising:
pulling a request from a task queue;
analyzing the request;
processing the request when capabilities needed to process the request are present, wherein at least one registered plug-in comprises at least one capability to process the request; and
storing the processed request for retrieval.
